(19) United States
(12) Patent Application Publication
(10) Pub. No.: US 2008/0176686 A1
(43) Pub. Date: Jul. 24, 2008

(54) Torque transmission device with enhanced ability to absorb change in rotation between torque input and output member

(75) Inventor: Nobuo Isogai, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, Kariya-City (JP)

(21) Appl. No.: 12/007,675

(22) Filed: Jan. 14, 2008

(30) Foreign Application Priority Data
Jan. 19, 2007 (JP) 2007-010456

(51) Int. Cl. F16H 55/36

(52) U.S. Cl. 474/11

(57) ABSTRACT

A torque transmission device which may be used to transmit torque, as inputted from an automotive engine through a belt, to an accessory such as an alternator and is designed to have enhanced ability to absorb a change in rotation of a torque input member relative to an torque output member. The torque transmission device includes a slider sensitive to a given change in rotation of the input member relative to the output member to experience sliding motion and an elastic absorber which suppresses the sliding motion elastically to absorb the change in rotation of the input member. The elastic absorber is mechanically retained by the output member and inertially independent of the input member, so that the moment of inertia of the input member will be small, thus resulting in enhanced ability to absorb the change in rotation of the input member.

### CROSS REFERENCE TO RELATED DOCUMENT

The present application claims the benefit of Japanese Patent Application No. 2007-10456 filed on Jan. 19, 2007, the disclosure of which is incorporated herein by reference.

### BACKGROUND OF THE INVENTION

1 Technical Field of the Invention

The present invention relates generally to a torque transmission device which may be used to transmit torque, as inputted from an automotive engine through a belt, to an automotive accessory such as an alternator, and more particularly to an improved structure of such a torque transmission device with enhanced ability to absorb a change in rotation between torque input and output members.

2 Background Art

In recent years, the consciousness of the global environmental challenges has been heightened. In order to save the fuel, automotive engines have been decreased in idle speed and friction thereof. In contrast, most automobiles install electric devices such as EPS (Electric Power Steering) devices, thus resulting in an increase in size of alternators, which leads to an increase in consumption of engine power. This facilitates the instability in rotation of the engine arising from a change in combustion of fuel in the engine, and the slippage or flutter of a belt extending from a crankshaft of the engine to an accessory, which results in a decrease in service life of the belt. In order to these drawbacks, Japanese Patent First Publication No. 2006-9899 teaches a torque transmission device equipped with a compression coil spring which connects between a pulley joined to the crankshaft of the engine through a belt and a rotor to which an accessory such as an alternator is attached to absorb a rapid change in rotation of the pulley.

The above type of torque transmission device may be designed to decrease the moment of inertia of an torque input part including the pulley that is to idle for enhancing the efficiency in absorbing torque pulsations. However, the compression coil spring or a movable annular race is secured to the pulley, so that it is difficult to decrease the moment of inertia of the torque input part desirably. The torque transmission device is, therefore, not good at absorbing the change in rotation of the engine.

### SUMMARY OF THE INVENTION

It is therefore a principal object of the invention to avoid the disadvantages of the prior art.

It is another object of the invention to provide an improved structure of a torque transmission device with enhanced ability to absorb a change in rotation between torque input and output members.

According to one aspect of the invention, there is provided a torque transmission device which may be employed to transmit torque, as inputted from an automotive engine through a belt, to an automotive accessory such as an alternator and is designed to have enhanced ability to absorb a rapid change in speed of a torque input part. The torque transmission device comprises: (a) an input member to which torque is inputted; (b) an output member from which the torque, as transmitted from the input member through a transmission path, is outputted; (c) a bearing mechanism supporting the input member and the output member to be rotatable relative to each other; (d) a slider sensitive to a given change in rotation of the input member relative to the output member to experience sliding motion along a given path; and (e) an elastic absorber working to suppress the sliding motion elastically to absorb the change in rotation of the input member relative to the output member. The elastic absorber is mechanically retained by the output member and inertially independent of the input member.

Specifically, the elastic absorber is not joined fixedly to the input member. In other words, when the speed of the input member changes, at least the elastic absorber does not follow the changed speed of the input member, so that the moment of inertia of the input member will be smaller than that in a conventional structure, like the one discussed above, thus resulting in enhanced ability to absorb the change in rotation of the input member.

In the preferred mode of the invention, the slider may also be mechanically joined to the elastic absorber and disposed to slide independently of the input member when being subjected to the change in rotation of the input member relative to the output member.

The slider may be made of a ball. The input member may be made of a hollow cylinder which has a first groove formed in an inner periphery thereof. Similarly, the output member may be made of a hollow cylinder which has a second groove formed in an outer periphery thereof and is disposed inside the input member to define between the first and second grooves the given path along which the slider slides when the slider is subjected to the given change in rotation of the input member relative to the output member.

The slider has a diameter A. The depth H1 of the first groove is selected to meet a relation of (A/2)>H1. Similarly, the depth H2 of the second groove is selected to meet a relation of (A/2)>H2. This ensures holding of the slider between the first and second grooves while allowing the first and second grooves to rotate relative to each other.

The first groove may be designed to extend in the form of a spiral in an axial direction of the input member to restrict movement of the slider in the axial direction. The second groove may be designed to extend straight in the axial direction of the output member to restrict movement of the slider in a circumferential direction of the input member. This defines the path along which the slider slides.

The elastic absorber is implemented by a spring. The torque transmission device further includes a slider retainer disposed between the slider and the spring to retain the slider in abutment therewith. The use of the slider retainer ensures the desired motion of the slider regardless of the configuration of an end of the spring with which the slider is placed in abutment. For example, the slider is made of a hollow cylinder.

The bearing mechanism is made up of two bearings disposed across the slider between the input and output members.

The input member may be designed to have a first annular member which protrudes inwardly from an inner periphery thereof and has the first groove formed in an end surface facing in an axial direction of the input member. The output member may also be designed to have a second annular member which protrudes outwardly from an outer periphery thereof and has the second groove formed on an end surface facing the end surface of the first annular member. The slider is disposed between the first and second grooves. The first and second annular members are sensitive to a change in angular position between the input and output members to change in relative positional relation between the first and second grooves in a radial direction of the first and second annular members to move the slider.

The input member may alternatively be designed to have a first annular member which protrudes inwardly from an inner periphery thereof and has the first groove formed in an end surface thereof facing in an axial direction of the input member to define a first ridge thereon. Similarly, the output member may be designed to have a second annular member which protrudes outwardly from an outer periphery thereof and has the second groove formed on an end surface thereof facing in an axial direction of the output member to define a second ridge thereon. The first ridge is fit in the second groove. The second ridge is fit in the first groove. The first and second annular members are sensitive to a change in angular position between the input and output members to change in relative positional relation between the first ridge and the second groove and between the second ridge and the first groove in a radial direction of the first and second annular members to move the slider.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partial longitudinal sectional view which shows a torque transmission device according to the first embodiment of the invention;

FIG. 2 is a perspective view which shows a hollow cylinder installed in the torque transmission device of FIG. 1;

FIG. 3 is a longitudinal sectional view which shows the structure of a torque pulsation absorbing mechanism installed in the torque transmission device of FIG. 1;

FIG. 4 is a partial longitudinal sectional view which shows a torque transmission device according to the second embodiment of the invention;

FIG. 5(a) is a partially sectional view which illustrates for the case where a slider is nipped between grooves without sliding along a path defined between the grooves in the second embodiment;

FIG. 5(b) is a partially sectional view which illustrates for the case where a slider slides along a path defined between grooves when a change in rotation of a pulley relative to a rotor shaft occurs in the second embodiment;

FIG. 6 is a partial longitudinal sectional view which shows a torque transmission device according to the third embodiment of the invention;

FIG. 7(a) is a partially sectional view which illustrates for the case where a slider is nipped between grooves without sliding along a path defined between the grooves in the third embodiment; and

FIG. 7(b) is a partially sectional view which illustrates for the case where a slider slides along a path defined between grooves when a change in rotation of a pulley relative to a rotor shaft occurs in the third embodiment.

### DESCRIPTION OF THE PREFERRED EMBODIMENTS

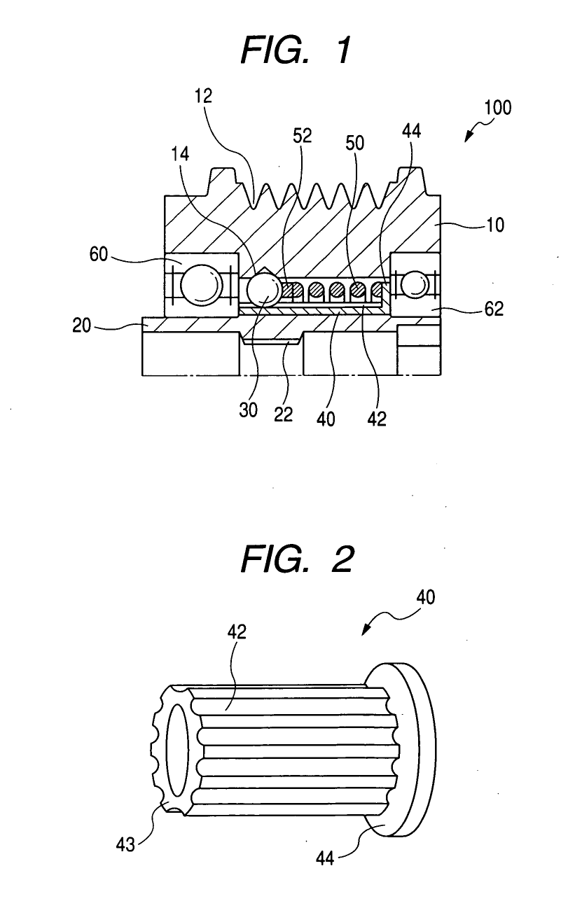

Referring to the drawings, wherein like reference numbers refer to like parts in several views, particularly to FIG. 1, there is shown a torque transmission device according to the first embodiment of the invention which will be discussed as being designed as a pulley unit for automotive alternators, but may be employed as that for another type of accessories such as automotive air conditioners.

FIG. 1 is a partially longitudinal sectional view which shows a half of the pulley unit 100 for the sake of simplicity of illustration. The pulley unit 100 includes a pulley 10, a rotor shaft 20, sliders 30, a hollow cylinder 40, a compression coil spring 50, a slider retainer tube 52, and bearings 60 and 62.

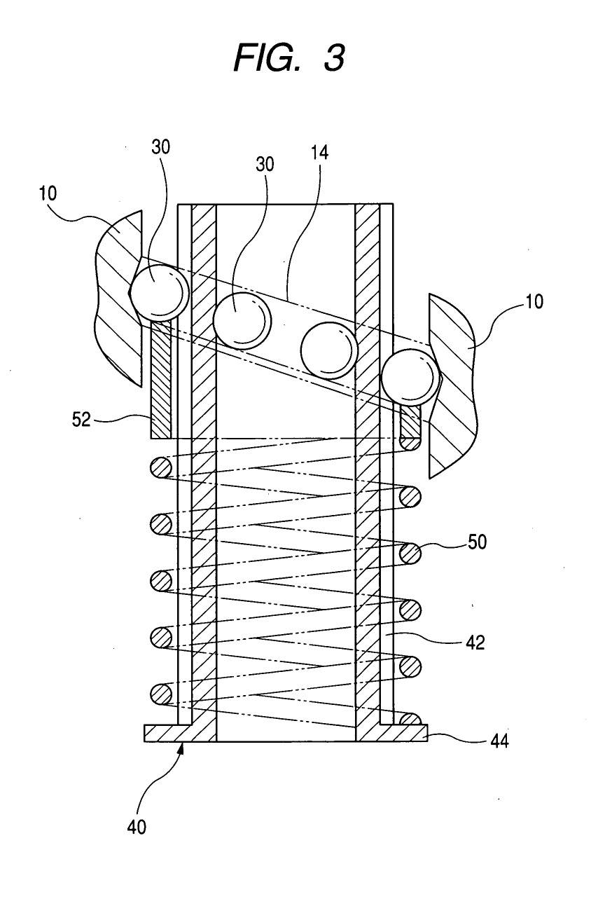

The pulley 10 is made of a hollow cylinder with V-grooves 12 around which a belt (not shown) is wound from a crankshaft of an automotive internal combustion engine (not shown). The pulley 10, as illustrated FIGS. 1 and 3, also has a spiral V-groove 14 (will also be referred to as a first groove below) formed in an inner periphery thereof. The spiral V-groove 14 extends in a lengthwise direction, like one turn of a typical coil spring, but may extend in the form of two or more of the coil spring or less than one turn of the coil spring. The rotor shaft 20 is made of a hollow cylinder working as an output shaft joined to an input shaft (not shown) of the alternator. The rotor shaft 20 has formed in an inner periphery thereof an internal thread 22a which makes a joint with an external thread formed in the shaft of the alternator firmly. The hollow cylinder 40 is fit on the outer periphery of the rotor shaft 20. The hollow cylinder 40 is, as clearly illustrated in FIG. 2, made up of a cylindrical body 43 and a flange 44 extending perpendicular to a length of the cylindrical body 43. The cylindrical body 43 has formed in the outer periphery thereof a plurality of grooves 42 (will also be referred to as second grooves below) which extend straight in parallel to a longitudinal center line thereof. The flange 44 is made of a disc and works as a stopper with which the compression coil spring 50 is placed in abutting contact. The rotor shaft 20 and the hollow cylinder 40 may alternatively be formed integrally with each other.

The compression coil spring 50 is, as clearly illustrated in FIG. 3, wound on the outer periphery of the hollow cylinder 40 coaxially therewith and has one of opposed ends joined or welded to the flange 44. The compression coil spring 50 is also joined or welded at the other end to an end of the slider retainer tube 52. The slider retainer tube 52 also has the other end with which the sliders 30 are placed in abutment. The slider retainer tube 52 may be joined firmly or welded to the sliders 30.

The sliders 30 are balls placed one in each of the second grooves 42 of the hollow cylinder 40. The sliders 30 move along the second grooves 42 upon a change in relative angular position between the pulley 10 and the hollow cylinder 40. Each of the sliders 30 is in slidable contact with the inner periphery (i.e., the first groove 14) of the pulley 10, so that it does not follow the rotation of the pulley 10. In FIG. 3, some of the sliders 30 are omitted for the ease of visibility, but there are as many sliders 30 as the second grooves 42 of the hollow cylinder 40. The end of the slider retainer tube 52 with which the sliders 30 abut is inclined to the axis (i.e., the longitudinal center line) of the slider retainer tube 52 in the form of a spiral. Each of the sliders 30 is fit in both the first groove 14 formed in the inner periphery of the pulley 10 and one of the second grooves 42 formed in the outer periphery of the hollow cylinder 40. The first groove 14 is, as described above, in the form of a spiral. The second grooves 42 extend, as described above, straight parallel to each other. Therefore, each of sliders 30 is restricted by the first groove 14 from moving in the longitudinal direction of the hollow cylinder 40 and by a corresponding one of the second grooves 42 from moving in the circumferential direction of the hollow cylinder 40. When the pulley 10 rotates relative to the hollow cylinder 40, in other words, a change in rotation of the pulley 10 relative to the rotor shaft 20 occurs, it will cause each of the sliders 30 to move in the longitudinal direction of the hollow cylinder 40.

The first groove 14 may be in the form of an oval, in other words, may be designed to extend in the form of a sine-wave when developed on a plane. The first groove 14 may also be in the form of a circular or semi-circular wave in the case where a change in angular position between the pulley 10 and the rotor shaft 20 is restively small. Specifically, the first groove 14 may be so shaped that the sliders 30 move in the lengthwise direction of the compression coil spring 50 when the pulley 10 and the hollow cylinder 40 (i.e., the rotor shaft 20) rotate relative to each other.

The end of the slider retainer tube 52 with which the sliders 30 abut is so shaped as to geometrically coincide with the first groove 14 in order to distribute the elastic pressure, as exerted by the compression coil spring 50, into uniform fractions acting on the sliders 30, respectively. In other words, the end of the slider retainer tube 52 and the first groove 14 extend spirally at the same angle to the longitudinal center line of the hollow cylinder 40. If the diameter of each of the sliders 30 is defined as A, the depth H1 of the first groove 14 is selected to meet a relation of (A/2)>H1. Similarly, the depth H2 of the second grooves 42 is selected to meet a relation of (A/2)>H2.

The bearings 60 and 62 are located away from each other in alignment with an axis of rotation of the pulley unit 100 across the sliders 30 to secure the rotor shaft 20 to be rotatable relative to the pulley 10. Each of the bearings 60 and 62 is, as clearly illustrated in FIG. 1, fit on the rotor shaft 20 and held at an inner ring thereof by a shoulder formed on the outer periphery of the rotor shaft 20 from moving in the axial direction of the rotor shaft 20, thereby positioning the pulley 10 in the axial direction thereof. The compression coil spring 50 and the sliders 30 are disposed between the bearings 60 and 62.

The operation of the pulley unit 100 will be described below.

When the pulley 10 is being rotated by the output torque from the engine in a steady state, the torque, as inputted to the pulley 10, is transmitted to the rotor shaft 20 along a torque transmission path extending from the pulley 10 to the rotor shaft 20 through the sliders 30, the slider retainer tube 52, the compression coil spring 50, and the hollow cylinder 40.

When the pulley 10 is accelerated from the steady state speed, it will result in a lag in rotation of the rotor shaft 20 because the rotor shaft 20 is joined firmly to a rotor of the automotive alternator, so that it has a great inertia. This results in a change in rotation (i.e. speed) of the pulley 10 relative to the rotor shaft 20 (i.e., the hollow cylinder 40), thus causing the first groove 14 of the pulley 10 to move relative to the second grooves 42 of the hollow cylinder 40 (i.e., the rotor shaft 20) to push the sliders 30 in a direction in which the compression coil spring 50 is compressed. The orientation of the end of the slider retainer tube 52 with which the sliders 30 abut and the first groove 14 relative to the axis of rotation of the pulley unit 100 are, as described above, selected to move the sliders 30 with movement of the pulley 10 relative to the rotor shaft 20. Accordingly, the part of the torque of the pulley 10 arising from a change in rotation thereof is absorbed by the compression coil spring 50. The rotor shaft 20 starts to accelerate behind the pulley 10. This ensures the transmission of torque from the pulley 10 to the rotor shaft 20 without torque pulsation. Conversely, when the pulley 10 is decelerated, it will result in a lag in deceleration of the rotor shaft 20. This causes the first groove 14 of the pulley 10 to rotate relative to the rotor shaft 20 to move the sliders 30 in a direction in which the compression coil spring 50 is stretched, thereby absorbing the torque of the pulley 10 partially. The rotor shaft 20 starts to decelerate behind the pulley 10. This ensures the transmission of torque from the pulley 10 to the rotor shaft 20 without torque pulsation.

As apparent from the above discussion, when the speed of the pulley 10 has changed rapidly, and the pulley 10 rotates relative to the rotor shaft 20, the sliders 30 and the compression coil spring 50 do not follow the changed rotation of the pulley 10. In other words, the sliders 30, the slider retainer tube 52, and the compression coil spring 50 are not joined rigidly to the pulley 10, but to the rotor shaft 20 through the hollow cylinder 40. Therefore, as compared with the conventional structure, as discussed in the introductory part of this application, the moment of inertial of a torque input part (i.e., the pulley 10) is small, thus enhancing the absorption of a change in speed of the pulley 10 in the pulley unit 100.

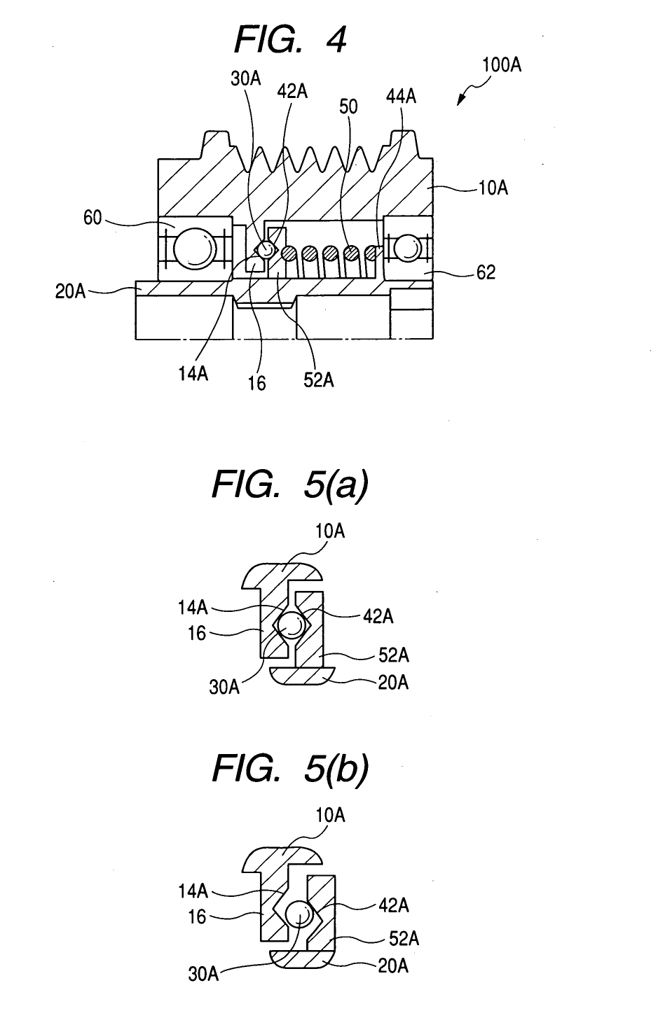

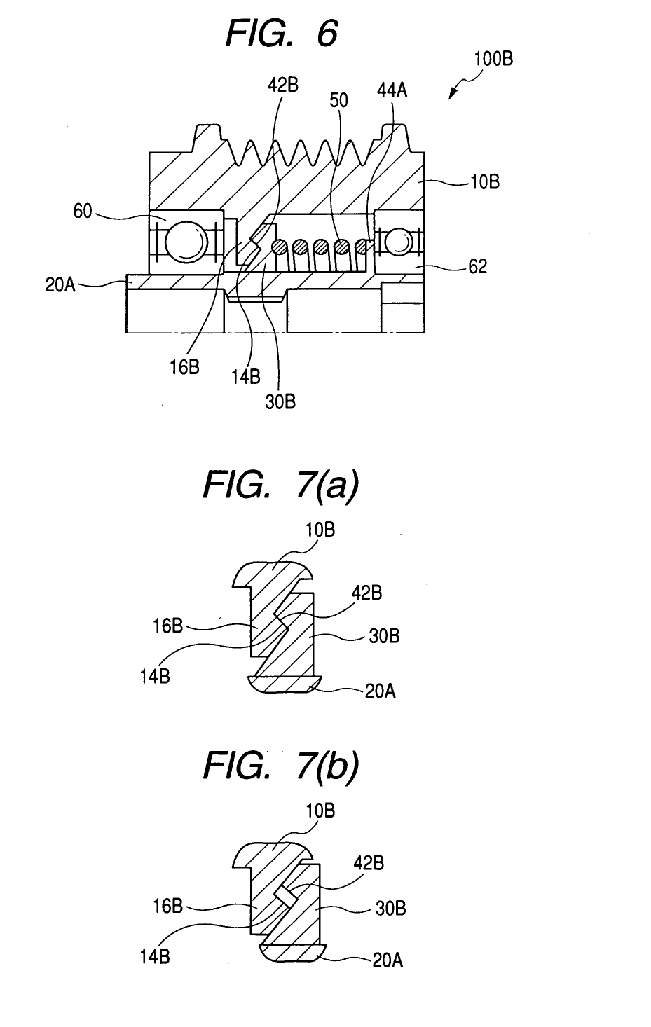

FIG. 4 illustrates a pulley unit 100A according to the second embodiment of the invention.

The pulley unit 100A includes a pulley 10A, a rotor shaft 20A, sliders 30A, a compression coil spring 50, a slider retainer 52A, bearings 60 and 62. The same reference numbers as employed in the first embodiment will refer to the same parts, and explanation thereof in detail will be omitted here. The reference numbers to which the letter “A” is affixed refer to modifications of the parts, as discussed in the first embodiment.

The pulley 10A has an annular ring 16 formed on an inner peripheral wall thereof. The annular ring 16 has a spiral V-groove 14A (will also be referred to as a first groove below) formed in a flat end surface thereof extending perpendicular to the longitudinal center line of the pulley 10A. The slider retainer 52A is made of an annular disc and fit on an outer periphery of the rotor shaft 20A. The slider retainer 52A has a spiral V-groove 42A (will also be referred to as a second groove below) formed in an end surface thereof facing the annular ring 16. The first groove 14A and the second groove 42A are identical in configuration or mirror-image symmetrical, so that they coincide with each other when the pulley 10A and the rotor shaft 20A are in a given angular relation to each other. When the pulley 10A and the rotor shaft 20A are shifted in angular position from each other, it will cause the first groove 14A and the second groove 42A to be shifted radially of the pulley 10A (i.e. the rotor shaft 20A) from each other.

In the case where a change in angular position between the pulley 10A and the rotor shaft 20A is restively small, one or both of the first groove 14A and the second groove 42A may alternatively be designed in the form of an oval, a circular or semi-circular wave, or a circle. In the case where both the first groove 14A and the second groove 42A are formed to be circular or circular arc, at least one of the first groove 14A and the second groove 42A need to be located eccentrically with the axis of rotation of the annular ring 16 and the annular disc 52A.

The rotor shaft 20A has an annular stopper 44A protruding outwardly. Instead of the annular stopper 44A, the hollow cylinder 40, as illustrated in FIG. 40, may be fit on the outer periphery of the rotor shaft 20. The compression coil spring 50 is, like in the first embodiment, placed in abutting contact of an end thereof with an end of the annular stopper 44A and secured firmly or welded thereto. The compression coil spring 50 is also joined or welded at the other end thereof to the slider retainer 52A. The slider retainer 52A is slidable on the rotor shaft 20A in the axial direction of the rotor shaft 20A, but held by the end of the compression coil spring 50 from rotating in the circumferential direction thereof. The degree to which the slider retainer 52A is held from rotating in the circumferential direction of the rotor shaft 20A may be enhanced by forming on the inner periphery of the slider retainer 52A a plurality of ridges which extend in the lengthwise direction of the rotor shaft 20A, machining in the outer periphery of the rotor shaft 20A a plurality of grooves extending in the same direction as the ridges, and engaging them.

The sliders 30A are, like in the first embodiment, balls and retained between the first groove 14A and the second groove 42A at a regular interval away from each other in the circumferential direction of the rotor shaft 20A. Such retaining of the sliders 30A at the regular interval may be achieved by a ball-cage assembly, as used in typical ball bearings.

The operation of the pulley unit 100A will be described below.

When the pulley 10A is driven by the belt to accelerate the rotor shaft 20A from a steady state speed, the rotor shaft 20A will lag behind the pulley 10A because the rotor shaft 20A joined firmly to a rotor of the automotive alternator has a great inertia. This causes the first groove 14A of the pulley 10A to rotate relative to the second groove 42A of the slider retainer 52A, thereby moving the sliders 30A radially and inwardly of the pulley 10A to compress the compression coil spring 50 through the slider retainer 52A.

FIG. 5(a) illustrates for the case where the first groove 14A of the pulley 10A coincides with the second groove 42A of the slider retainer 52A in the longitudinal direction of the rotor shaft 20A. The first groove 14A and the second groove 42A are, as described above, of a V-shape in cross section. When the pulley 10A and the rotor shaft 20A are rotating in the steady state, the first groove 14A and the second groove 42A are aligned with each other in the longitudinal direction of the rotor shaft 20A, so that the distance between the annular ring 16 and the slider retainer 52A across the sliders 30A in the axial direction of the pulley unit 100A is minimized, and the sliders 30A are retained firmly between the annular ring 16 and the annular disc 52A, thereby transmitting the torque from the pulley 10A to the rotor shaft 20A. FIG. 5(b) illustrates for the case where the pulley 10A (i.e., the annular ring 16) rotates relative to the rotor shaft 20A (i.e., the slider retainer 52A), so that the first groove 14A of the pulley 10A is shifted from the second groove 42A in the circumferential direction of the pulley 10A to exert the pressure on the sliders 30A in the axial direction of the rotor shaft 20A, thereby pushing the slider retainer 52A to compress the compression coil spring 50. Specifically, the slider retainer 52A is moved apart from the annular ring 16 as a function of a shift in angular position of the first groove 14A from the second groove 42A, thereby compressing the compression coil spring 50. This causes the torque of the pulley 10A to be partially absorbed by the compression coil spring 50. The rotor shaft 20A starts to accelerate behind the pulley 10A. This ensures the transmission of torque from the pulley 10 to the rotor shaft 20 without torque pulsation.

Conversely, when the pulley 10A is decelerated, it will result in a lag in deceleration of the rotor shaft 20A. This causes, like the above, the slider retainer 52A to be moved to compress the compression coil spring 50, thereby absorbing the torque of the pulley 10A partially. The rotor shaft 20A starts to decelerate behind the pulley 10A.

FIG. 4 illustrates a pulley unit 100B according to the third embodiment of the invention.

The pulley unit 100B includes a pulley 10B, a rotor shaft 20A, a slider 30B, a compression coil spring 50, bearings 60 and 62. The same reference numbers as employed in the first and second embodiment will refer to the same parts, and explanation thereof in detail will be omitted here. The reference numbers to which the letter “B” is affixed refer to modifications of the parts, as discussed in the first or second embodiment.

The pulley 10B has an annular ring 16B formed on an inner peripheral wall thereof. The annular ring 16B has a spiral V-groove 14B (will also be referred to as a first groove below) formed in an end surface thereof extending perpendicular to the longitudinal center line of the pulley 10B to define a spiral barb-like ridge.

The slider 30B is an annular disc fit on an outer periphery of the rotor shaft 20A and works as a combination of the sliders 30A and the slider retainer 52A illustrated in FIG. 4. The slider 30B has a spiral V-groove 42B (will also be referred to as a second groove below) formed in an end surface thereof facing the annular ring 16B of the pulley 10B to define a spiral barb-like ridge. The first groove 14B and the second groove 42B are so shaped,that the barb-like ridge, as defined by the first groove 14B on the annular ring 16B, engages or just fits in the second groove 42B, while the barb-like ridge, as defined by the second groove 42B on the slider 30B, just fits in the first groove 14B when the pulley 10B and the rotor shaft 20A are in a given angular position. When the pulley 10B and the rotor shaft 20A are shifted relative to each other from the initial angular position, it will cause the barb-like ridges on the annular ring 16B and the slider 30B to be shifted radially of the pulley 10B (i.e. the rotor shaft 20A) from each other.

In the case where a change in angular position between the pulley 10B and the rotor shaft 20A is restively small, one or both of the first groove 14B and the second groove 42B may alternatively be designed in the form of an oval, a circular or semi-circular wave, or a circle. In the case where both the first groove 14B and the second groove 42B are formed to be circular or circular arc, at least one of the first groove 14B and the second groove 42B need to be located eccentrically with the axis of rotation of the annular ring 16B and the slider 30B.

The compression coil spring 50 is, like in the first embodiment, joined or welded at an end thereof with an end of the annular stopper 44A and also joined or welded at the other end thereof to the slider 30B. The slider 30B is slidable along the outer periphery of the rotor shaft 20A in the axial direction of the rotor shaft 20A, but held by the end of the compression coil spring 50 from rotating in the circumferential direction thereof.

The operation of the pulley unit 100B will be described below.

When the pulley 10B is driven by the belt to accelerate the rotor shaft 20A from a steady state speed, the rotor shaft 20A will lag behind the pulley 10B because the rotor shaft 20A joined firmly to a rotor of the automotive alternator has a great inertia. This causes the first groove 14B of the pulley 10A to rotate relative to the second groove 42B of the slider 30B, thereby causing the barb-like ridges on the annular ring 16B and the slider 30B to be shifted radially of the pulley 10B to move the slider 30B in the axial direction of the stator shaft 20A to compress the compression coil spring 50.

FIG. 7(a) illustrates for the case where the spiral barb-like ridge, as defined by the first groove 14B on the annular ring 16B, is just fit in the second groove 42B, while the spiral barb-like ridge, as defined by the second groove 42B on the slider 30B, is just fit in the first groove 14B when the pulley 10B and the rotor shaft 20A are in the given angular position. Each of the barb-like ridges may engage a corresponding one of the first groove 14B and the second groove 42B with play or a gap.

FIG. 7(b) illustrates for the case where the pulley 10B and the rotor shaft 20A are shifted relative to each other from the angular position in FIG. 7(a), so that the barb-like ridges on the annular ring 16B and the slider 30B are shifted radially from each other to push the slider 30B in the rightward direction, as viewed in the drawing. Specifically, the slider 30B is moved apart from the annular ring 16B as a function of a shift in angular position of the first groove 14B from the second groove 42B, thereby compressing the compression coil spring 50. This causes the torque of the pulley 10B to be partially absorbed by the compression coil spring 50. The rotor shaft 20A starts to accelerate behind the pulley 10B. This ensures the transmission of torque from the pulley 10B to the rotor shaft 20A without torque pulsation.

Conversely, when the pulley 10B is decelerated, it will result in a lag in deceleration of the rotor shaft 20A. This causes, like the above, the slider 30B to be moved to compress the compression coil spring 50, thereby absorbing the torque of the pulley 10B partially. The rotor shaft 20A starts to decelerate behind the pulley 10B. This eliminates the pulsation of rotation of the pulley 10B.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A torque transmission device comprising:
an input member to which torque is inputted;
an output member from which the torque, as transmitted from said input member through a transmission path, is outputted;
a bearing mechanism supporting said input member and said output member to be rotatable relative to each other;
a slider sensitive to a given change in rotation of said input member relative to said output member to experience sliding motion along a given path; and
an elastic absorber working to suppress the sliding motion elastically to absorb the change in rotation of said input member relative to said output member, said elastic absorber being mechanically retained by said output member and inertially independent of said input member.

2. A torque transmission device as set forth in claim 1, wherein said slider is mechanically joined to said elastic absorber and disposed to slide independently of said input member when being subjected to the change in rotation of said input member relative to said output member.

3. A torque transmission device as set forth in claim 1, wherein said slider is made of a ball, and wherein said input member is made of a hollow cylinder which has a first groove formed in an inner periphery thereof, and said output member is made of a hollow cylinder which has a second groove formed in an outer periphery thereof and is disposed inside said input member to define between the first and second grooves the given path along which said slider slides when said slider is subjected to the given change in rotation of said input member relative to said output member.

4. A torque transmission device as set forth in claim 3, wherein said slider has a diameter A, and wherein a depth H1 of the first groove is selected to meet a relation of (A/2)>H1, and a depth H2 of the second groove is selected to meet a relation of (A/2)>H2.

5. A torque transmission device as set forth in claim 3, wherein the first groove extends in the form of a spiral in an axial direction of said input member, and wherein the second groove extends straight in the axial direction of said output member.

6. A torque transmission device as set forth in claim 1, wherein said elastic absorber is implemented by a spring, and further comprising a slider retainer disposed between said slider and the spring to retain said slider in abutment therewith.

7. A torque transmission device as set forth in claim 6, wherein said slider retainer is made of a hollow cylinder.

8. A torque transmission device as set forth in claim 4, wherein said bearing mechanism is made up of two bearings disposed across said slider between said input and output members.

9. A torque transmission device as set forth in claim 1, wherein said input member is made of a hollow cylinder, and said output member is made of a hollow cylinder disposed inside said input member, and wherein said input member has a first annular member which protrudes inwardly from an inner periphery thereof and has the first groove formed in an end surface facing in an axial direction of the input member, and said output member has a second annular member which protrudes outwardly from an outer periphery thereof and has the second groove formed on an end surface facing the end surface of the first annular member, and wherein said slider is disposed between the first and second grooves, and the first and second annular members are sensitive to a change in angular position between said input and output members to change in relative positional relation between the first and second grooves in a radial direction of the first and second annular members to move said slider.

10. A torque transmission device as set forth in claim 1, wherein said input member is made of a hollow cylinder, and said output member is made of a hollow cylinder disposed inside said input member, and wherein said input member has a first annular member which protrudes inwardly from an inner periphery thereof and has the first groove formed in an end surface thereof facing in an axial direction of said input member to define a first ridge thereon, and said output member has a second annular member which protrudes outwardly from an outer periphery thereof and has the second groove formed on an end surface thereof facing in an axial direction of said output member to define a second ridge thereon, the first ridge being fit in the second groove, the second ridge being fit in the first groove, and wherein the first and second annular members being sensitive to a change in angular position between said input and output members to change in relative positional relation between the first ridge and the second groove and between the second ridge and the first groove in a radial direction of the first and second annular members to move said slider.
